(19) United States
(12) Patent Application Publication
(10) Pub. No.: US 2003/0130008 A1
(43) Pub. Date: Jul. 10, 2003

(54) Updating of subscriber information

(76) Inventors: Jaakko Rajaniemi, Helsinki (FI); Lauri Heiskanen, Vantaa (FI)

Correspondence Address: COHEN, PONTANI, LIEBERMAN & PAVANE, 551 FIFTH AVENUE, SUITE 1210, NEW YORK, NY, 10176, US

(21) Appl. No.: 10/221,524

(22) PCT Filed: Mar. 16, 2001
(86) PCT No.: PCT/FI01/00261

(30) Foreign Application Priority Data
Mar. 16, 2000 (FI) 20000616

(51) Int. Cl. H04B 1/38; H04Q 7/20

(52) U.S. Cl. 455/551; 455/435

(57) ABSTRACT

This invention relates to a method for updating subscriber identifier information in a first mobile communication network, in which a mobile station of the network can incorporate one or more subscriber identifiers, and which subscriber identifiers have a common subscriber identifier. According to the method, when a connection is established between the mobile station and the second telecommunication network, at least the information of the common subscriber identifier of the first identifier to the mobile communication network is updated from the network element that connects said networks. The invention also relates to a network element for updating subscriber identifier information in a mobile information is used communication network. The network element according to the invention comprises first means (801) for transmitting and identifying signals, second means (802) for transmitting an identification request, third means (803) for processing identification information and fourth means (804) for transmitting an updating message. The invention also relates to a telecommunication system.

This invention relates to a method, on the basis of which the updating of subscriber identifier information can be advantageously arranged. In particular, the invention relates to the updating of subscriber identifier information in the case of a third generation mobile communication network.

Connecting separate telecommunication networks to each other requires many different arrangements to ensure that two separate telecommunication networks operate flawlessly together in all situations. One such arrangement, which requires special attention, is arranging the control of subscriber connections and especially the paging of an individual subscriber. This arrangement becomes especially important in a case when a connection is established between telecommunication networks, the first of which contains information about the subscriber's connections, and corresponding information is not found in the second telecommunication network.

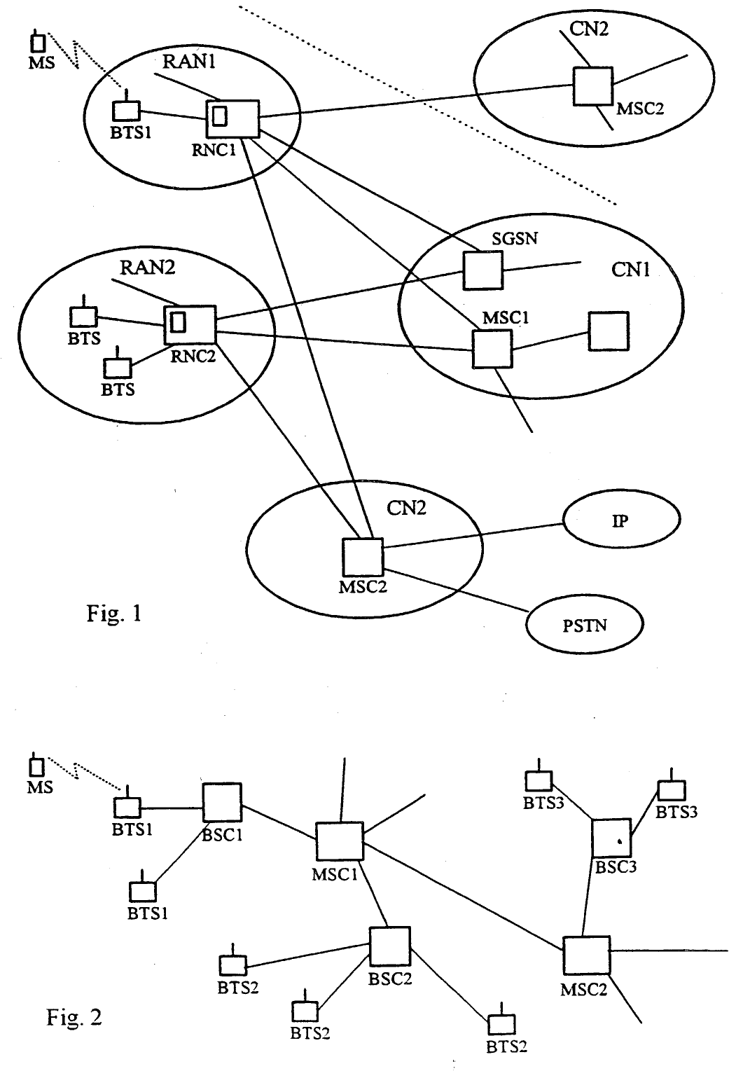

By way of example, we shall now discuss a third generation mobile communication network shown in FIG. 1, in which the terminal device can incorporate many subscriber identifiers. The telecommunication network shown in FIG. 1 is a UMTS (Universal Mobile Telecommunication System) network, the basic structure or which is shown in FIG. 1. An UMTS network typically includes at least one Core Network (CN) and one or more Radio Access Networks (RAN). The core network comprises Mobile Switching Centres (MSC) and possibly other service nodes. “Node” is here a general name for network parts, which perform switching; thus it also covers mobile switching centres and other central devices. The radio access networks are between the core network and the terminal devices. The radio access network includes Base Transceiver Stations (BTS) and a Radio Network Controller (RNC). There is a permanent connection to the Radio Network Controller (RNC) from each base station (BTS). Then, again, there is a permanent connection from the radio network controllers to at least one node of a core network. The core networks can also be connected to other network topologies, such as an IP network or a public switched telephone network (PSTN).

In third generation mobile communication networks, paging an individual subscriber identifier takes place so that when the paging message comes to the node to which the subscriber is registered at the moment, the node sends a locationing request via a radio network controller to the base stations, in the area of which the paged subscriber is according to the register information. A mobile station, which detects the information of the subscriber identifier in its use in the paging channel which it monitors, sends a response message to the base station. As a consequence, the system updates the common subscriber identifier (CommonID) in the radio network controller. The common subscriber identifier means an identifier, by which the radio network controller can coordinate the corresponding paging requests of other nodes in a situation where the mobile station has connections with at least one other node, and a new node wants to establish a new connection with the same mobile station. If more than one subscriber identifiers have been arranged in the mobile station, the common subscriber identifier can be regarded as a kind of a common part of separate subscriber identifiers or a sum of separate subscriber identifiers. If only one subscriber identifier has been arranged in the mobile station, in this case this subscriber identifier is typically the common subscriber identifier. The process for updating the common subscriber identifier takes place if the node in question does not previously have connections to the subscriber(s), which is/are in the same mobile station. If the subscriber identifier in the mobile station has a connection, this connection is seen in the common identifier information in the radio network controller RNC. If more than one subscriber identifiers have been arranged in the mobile station and an attempt is made to establish a connection to another subscriber identifier in the same mobile station, the common subscriber identifier information about an existing connection, said information being saved in the radio network controller RNC, can be utilized. Information of the common subscriber identifier is updated with a CommonID Update message, which is sent by a third generation mobile switching centre to a radio network controller (RNC) after the mobile station has been identified. An arrangement like this can save the resources of the telecommunication network, because then unnecessary locationing requests for reaching a certain subscriber identifier in the same mobile station are not sent.

FIG. 2 shows a telecommunication network widely used today, in the terminal devices of which only one subscriber identifier can be used. The mobile communication network shown in FIG. 2 is a GSM (Global System for Mobile communications) network. Typically, a GSM network comprises mobile switching centres MSC, to which the mobile stations MS have been connected via the base station network. The base station network typically comprises base stations BTS and base station controllers BSC. From each base station BTS, there is a permanent connection to the base station controller BSC of that base station, and further from each base station controller BSC, there is a permanent connection to the mobile switching centre MSC. The mobile stations MS communicate via the radio path with the base stations BTS.

As known, the general principle of paging, i.e. locationing the subscriber in a digital mobile communication network, such as the GSM network, is the following: When a paging message has come to the node, such as the mobile switching centre MSC, to which the subscriber is registered at the moment, the switching centre sends a locationing request via the radio network controllers to the base stations, in the area of which the paged subscriber is according to the register information. The base stations send a paging message to the radio path on their paging channels PCH. A mobile station, which detects the subscriber identifier in its use in the paging channel which it monitors, sends a response message to the base station. In this way, the network gets information about the location of the paged subscriber at the accuracy of a cell, and the data connection can be switched. In this description and the claims, a “data connection” means a connection to be established for the actual signal to be transferred. The most common type of data connection is a speed connection.

The operation of second and third generation mobile communication networks is advantageously arranged so that a connection can be established from both networks both to a mobile station in the same network and a mobile station in another network. Then it would be advantageous, if both systems could utilize the properties of each other e.g. in connection with the locationing and paging of a subscriber. However, a problem is encountered in the fact that the current second generation mobile communication systems do not have a corresponding CommonID operation as the one discussed above in connection with the description of the third generation mobile communication network. Thus the mobile switching centre MSC of a second generation mobile communication network cannot send a CommonID Update message to the network elements of a third generation mobile communication network. In practice, this means that e.g. in a situation where a subscriber identifier of a third generation mobile station has a connection to a second generation mobile communication network, no information is transmitted to the radio network controller RNC of the third generation mobile communication network about an existing connection, and the information of the common subscriber identifier is not updated, because the second generation system does not recognize such an updating operation by which information about an existing connection can be transmitted to the network element. As a result of this, especially in a situation where an attempt is made to establish a connection to another subscriber identifier in the same mobile station or from another node of the network to the subscriber, it is not possible to utilize e.g. location information of an existing connection, and unnecessary locationing of subscriber identifiers must be performed. In a situation like this, it is not possible to establish a connection at all, because the mobile station does not listen to any paging channels but expects all new connections to be established on an existing signalling channel, which is coordinated by the radio network controller RNC. The objective of this invention is to provide a method, a network element and a mobile communication system, by which the problems described above can be eliminated.

The objectives of the invention are achieved by arranging in a network element between two different data transfer systems an operation, by which information about existing connections to at least one subscriber identifier in a certain mobile station can be updated in the network element, in which information about said connections is stored.

The method according to the invention for updating subscriber identifier information in a first telecommunication network, in which a common subscriber identifier has been arranged for an individual mobile station, and a connection is established between a mobile station of said first mobile communication network and another telecommunication network, is characterized in that when a connection is established between said mobile station and another telecommunication network, at least the information of the common subscriber identifier of the first mobile communication network is updated from the network element that connects said networks.

The network element according to the invention for updating subscriber identifier information in the first mobile communication network, in which first mobile communication network a common subscriber identifier has been arranged for an individual mobile station, and a connection is arrangable between a mobile station of said first mobile communication network and the second telecommunication network, is characterized in that said network element comprises

first means for transmitting and identifying signals between the first mobile communication network and the second telecommunication network,

second means for transmitting an identification request,

third means for processing the identification information, and

fourth means for transmitting an updating message.

A telecommunication system according to the invention, which comprises at least two telecommunication networks, and in which a common subscriber identifier has been arranged in at least one telecommunication network for an individual mobile station, and a connection is arrangable between a mobile station of said mobile communication network and at least one other telecommunication network, is characterized in that said telecommunication system comprises means between said telecommunication network and said at least one other telecommunication network for updating the information of the common subscriber identifier with an updating message.

Preferred embodiments of the invention are set forth in the dependent claims.

According to the invention, the operations of two different telecommunication systems are connected to each other preferably by such a network element, which recognizes the signals used in both systems, and which can advantageously convert the signals of the first system suitable for the second system and vice versa. According to the invention, by means of a procedure arranged in the network element, information about an existing connection to at least one subscriber identifier in the mobile station can be transmitted at least to the network element in which information about existing connections is stored. According to the invention, the information of the common subscriber identifier is advantageously updated in said network element. According to an arrangement according to the invention, information in the network about existing connections can be utilized in the mobile communication systems of both the second and third generation, whereby redundant paging of subscriber identifiers and transmission of paging messages can be avoided.

In the following, the invention will be described in more detail with reference to the accompanying drawings, of which

FIG. 1 shows a third generation mobile communication system,

FIG. 2 shows a second generation mobile communication system,

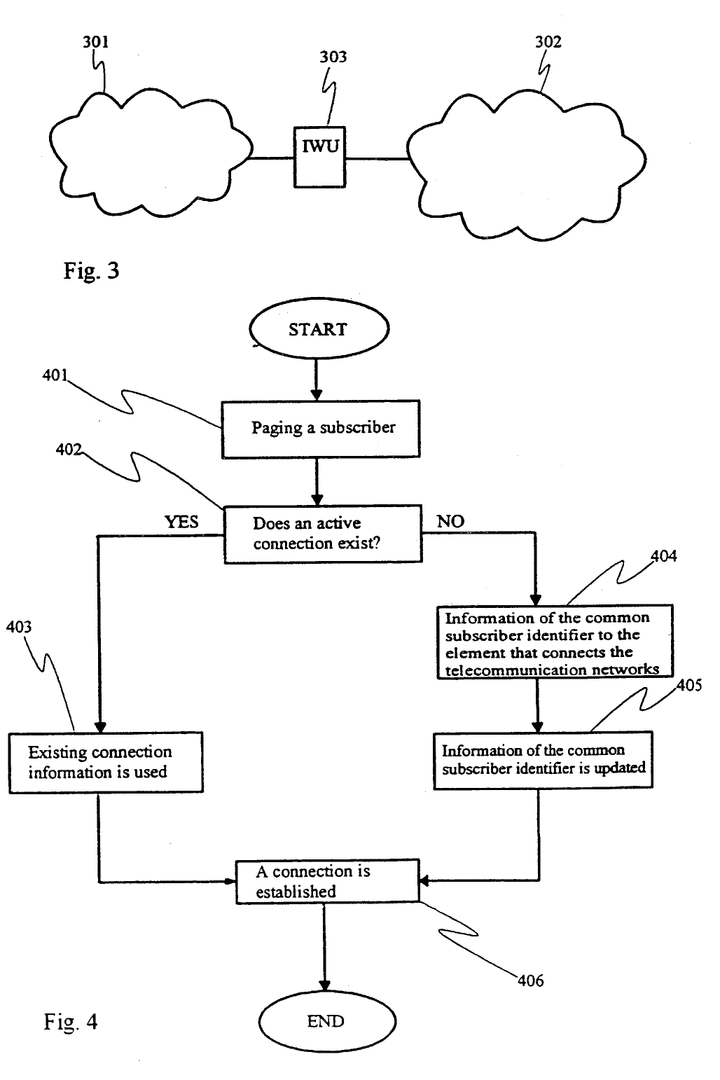

FIG. 3 shows an arrangement according to the invention for connecting two different telecommunication networks to each other,

FIG. 4 shows a flow chart of a method according to the invention,

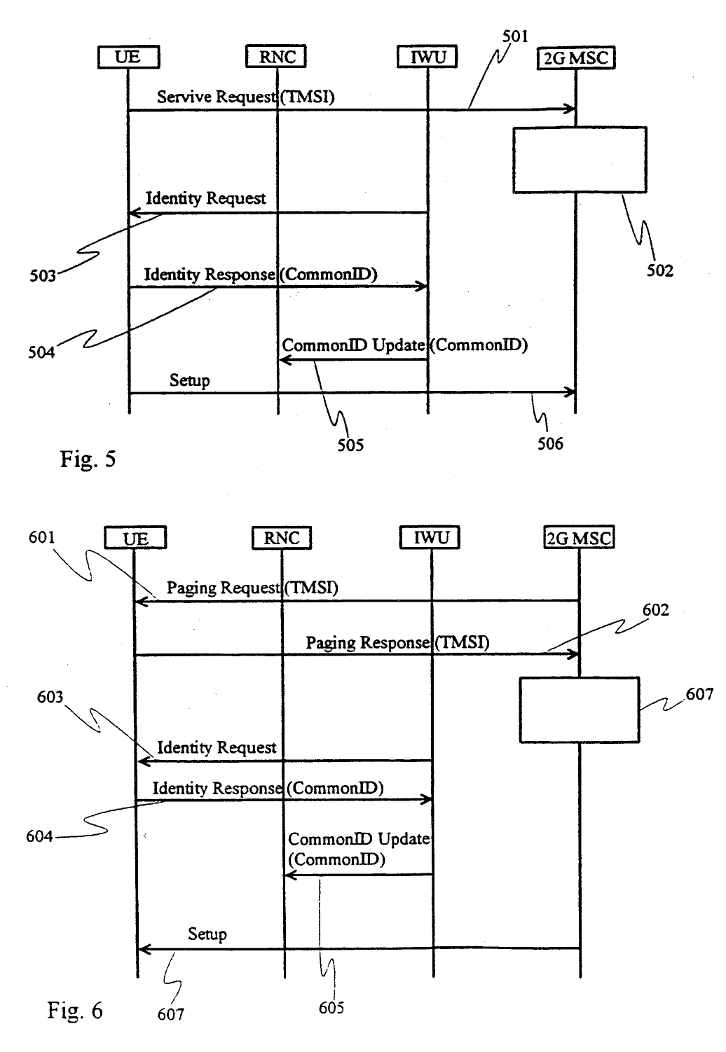

FIG. 5 shows a first method according to the invention for updating subscriber information,

FIG. 6 shows another method according to the invention for updating subscriber information,

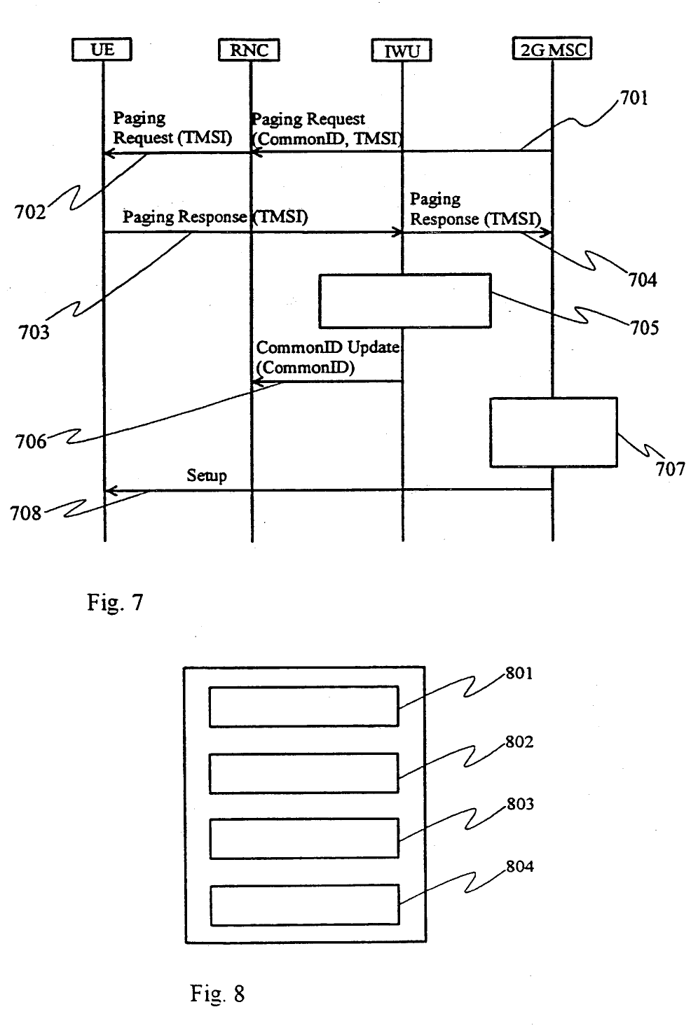

FIG. 7 shows a third method according to the invention for updating subscriber information, and

FIG. 8 shows a network element according to the invention.

The same reference numbers and markings are used for corresponding parts in the figures. FIGS. 1 and 2 have been discussed above in connection with the description of the prior art.

FIG. 3 shows one way of connecting two telecommunication networks to each other. For example, the first of these networks 301 may be a GSM network, and the second one 302 a third generation UMTS network, for example. In order to enable cooperation between these two different data transfer systems, there are so-called InterWorking Units (IWU) 303 between them. The tasks of these interworking units 303 include at least conversion of signalling messages and data fields included in them between formats of different systems. According to this invention, the IWU 303 is also arranged to implement the updating of the common subscriber identifier, CommonID, to the network element of a third generation mobile communication system, in which information about the CommonID is stored. Unnecessary paging of subscribers can be avoided by such an arrangement, because if the network already has information about an existing connection to a subscriber identifier in the same mobile station, this information can be advantageously used in the paging procedures of another subscriber identifier in the same mobile station. An example of such information is the location information of the mobile station, which information can be used to locate the subscriber identifier being paged in a simple manner and short time. It is clear to a person skilled in the art that although FIG. 3 only shows how two different telecommunication networks are connected to each other by an interworking unit 303, it is also possible to connect more than two telecommunication networks to the interworking unit 303 and to arrange the interworking unit 303 to enable communication between all telecommunication networks connected to it.

FIG. 4 illustrates the method according to the invention as a flow chart. In this flow chart it has been assumed that a data connection is established between the first and the second telecommunication network. In addition, it is assumed that a mobile station can comprise more than one individual subscriber identifiers. According to FIG. 4, a certain subscriber 401 is paged in the network. When the paging request has been received, it is checked 402 whether there is already information in the network about an active connection to another subscriber identifier in the same mobile station. If there is an active connection to another subscriber identifier of the same mobile station, the information of the common identifier 403 is advantageously utilized, and a connection is established to another subscriber identifier 406 by means of this information. Unnecessary paging of a subscriber identifier by using the paging channels PCH is thus avoided, because the location information of the mobile station in the network, for example, is utilized. If information is not found in the network about an existing connection to another subscriber identifier in the same mobile station, information of the common subscriber identifier, relating to subscriber identifiers in the same mobile station, is advantageously stored 404 e.g. in the network element, which connects two different telecommunication networks. In the next step, information of the common subscriber identifier is updated in the network element 405, in which the information about the common subscriber identifier is stored. Updating can take place e.g. by a separate updating message, which is sent by an element connecting the networks, and which message comprises at least information about the subscriber identifier to which or from which the connection is being established. Finally, when the operations related to the authentication and encryption of the data connection have been performed, the connection can be established 406. It is clear to a person skilled in the art that if the mobile station comprises only one subscriber identifier, existing connection information to another subscriber identifier is not found, and then the operation proceeds according to the right side of FIG. 4.

FIG. 5 shows a method according to a preferred embodiment of the invention for updating the information of the common subscriber identifier. This exemplary case is a situation where a mobile station UE of a first telecommunication network wants to establish a connection to a network element or terminal device of a second telecommunication network. In this exemplary embodiment, said first telecommunication network is a third generation UMTS network, and said second telecommunication network is a GSM network. In the situation shown in FIG. 5, the mobile station sends a Service Request (TMSI) 501 to the mobile switching centre 2G MSC of the second mobile communication network, in which service request it transmits a TMSI (Temporal Mobile Subscriber Identity) code. The TMSI code is a temporary code, by which the subscriber can be identified and by which the encrypting parameters can be determined. When the service request has arrived at the mobile switching centre 2G MSC of the second generation mobile communication network, the authentication of the subscriber and encryption 502 of the connection is advantageously performed. Because the service request passes from a third generation mobile communication network to a second generation mobile communication network, the interworking unit IWU 33 detects it and sends to the mobile station LE an Identity Request 503, in which it asks for the information of the common subscriber identifier, relating to the subscriber identifiers in the same mobile station. Advantageously, the mobile station LE transmits the information of the common subscriber identifier to the interworking unit IWU in an Identity Response (CommonID) message 504. When the IVU has received this identification information, it preferably gives, according to the invention, to a network element of a third generation mobile communication network, such as a radio network controller RNC, a command to update the information of the common subscriber identifier by means of an updating message CommonID Update (CommonID) 505. As a parameter of the CommonID Update message, the IWU gives the information of the common subscriber identifier. The radio network controller RNC updates the information of the common subscriber identifier so that it appears from that information that there is an active connection to a certain individual subscriber identifier under the common subscriber identifier After updating the information, the service request can be served and a connection Setup 506 can be performed from the mobile station UE to another telecommunication system, which in this exemplary embodiment is a second generation mobile communication network.

FIG. 6 shows a situation where a connection is set up from a second generation mobile communication network, such as the GSM network, to a subscriber who uses the services of a third generation mobile communication network. In this exempla) case, the second generation mobile switching centre 2G MSC has received a service request asking to page a certain subscriber identifier of a third generation mobile communication network. The mobile switching centre 2G MSC transmits the Paging Request (TMSI) via the interworking unit IWU and radio network controller RNC to the base station network, the base stations of which transmit the paging request forward in their own areas. The Paging Request (TMSI) includes the TMSI code of the paged subscriber identifier as a parameter. The mobile station UE 601, in which the paged subscriber identifier is located, detects the paging request and transmits a Paging Response (TMSI) message to the second generation mobile switching centre 2G MSC 602 via the network elements of the third generation mobile communication network. The paging response message includes the TMSI code as a parameter. In the next step, the interworking unit IWU, which has detected communication through it, sends an Identity Request to the mobile station UE 603, asking for the information of the common subscriber identifier. The mobile station UE transmits the information of the common subscriber identifier in its Identity Response (CommonID) message to the interworking unit IWU 604. At least the information of the common subscriber identifier is transmitted as a parameter in the message. When the interworking unit IWU has received the information of the common subscriber identifier, the information of which is being updated, it sends a CommonID Update (CommonID) message to the radio network controller RNC 605. Information of the common subscriber identifier is transmitted in the CommonID Update (CommonID) message, whereby the radio network controller RNC can update the information of the common subscriber identifier, under which the individual subscriber identifier related to the establishment of the connection is. The information to be updated includes at least information, which indicates that there is an active connection to at least one subscriber identifier under the common subscriber identifier. After that, setting up the connection, 607 Setup, can be performed, but on the condition that the mobile switching centre 2G MSC of the second generation mobile communication network has identified the subscriber or the basis of the Paging Response (TMSI) message described above and performed the required encrypting operations for encrypting the connection 606.

FIG. 7 shows another situation in which the arrangement according to the invention can be utilized when a mobile switching centre 2G MSC of a second generation mobile communication system is paging a subscriber identifier in a mobile station UE of a third generation mobile communication network. In the Paging Request (CommonID, TMSI), information of the common subscriber identifier and the TMSI code 701 are transmitted as parameters, of which the interworking unit IWU stores the information of the common subscriber identifier and the TMSI code 701, when the paging request is transmitted through it to the radio network controller RNC of a third generation mobile communication network. The radio network controller RNC transmits the Paging Request (TMSI) further to the mobile station UE 702. This Paging Request (TMSI) includes at least the TMSI code as a parameter. The mobile station UE replies to this Paging Request (TMSI) by transmitting a Paging Response (TMSI) 703 to the interworking unit IWU. The interworking unit IWU transmits the paging response further to the mobile switching centre 2G MSC of a second generation mobile communication network. The interworking unit IWU combines the information of the common subscriber identifier and the information of the TMSI code 705. By means of this information, the interworking unit IWU can update the information of the common subscriber identifier by sending to the radio network controller RNC a CommonID Update (CommonID) message 706, which advantageously includes the information of the common subscriber identifier as a parameter. The mobile switching centre 2G MSC advantageously performs the authentication of the subscriber and the encryption of the connection 707, after which the connection can be set up and the Setup message 708 can be transmitted to the mobile station UE of a third generation mobile communication system.

It is clear to a person skilled in the art that the common subscriber identifier CommonID can be any agreed subscriber identifier. It can be an IMSI code of a subscriber identifier in the same mobile station, a TMSI code or some other agreed identifier, such as a device code. Especially when the mobile station comprises only one subscriber identifier, the IMSI code of said one subscriber identifier is advantageously selected as the common subscriber identifier. It is also clear to a person skilled in the art that other identifiers than the ones mentioned above can also be used as parameters in the above mentioned messages.

FIG. 8 illustrates a network element according to the invention. The network element can be, for example, an interworking unit IWU. It is clear to a person skilled in the art that operations corresponding to the interworking unit IWU can also be arranged in some other network element. A network element like this can be a network element of telecommunication networks, such as a radio network controller RNC of an UMTS network. The network element according to the invention comprises first means 801 for transmitting and identifying the signals. By these means 801 the network element according to the invention detects the service requests sent by the mobile station UE and paging requests related to the paging of the mobile station UE, and the related response messages. The network element according to the invention comprises second means 802, which are arranged to transmit an identification request to the mobile station, which is setting up a connection or to which a connection is being set up. In addition, the network element comprises third means 803, by which the identification information sent by the mobile station can be processed. Processing can mean, for example, connecting identification information, such as the TMSI code, and information of the common subscriber identifier to each other. Furthermore, the network element comprises fourth means 804 for transmitting an updating message. In the updating message, information is transmitted to a network element of the second system about an active connection of a subscriber identifier, on the basis of which the network element in question updates the information of the common subscriber identifier. The means described above can be implemented in a network element according to the invention as programs, for example. In that case, a processor, such as a microprocessor, which is arranged to execute the programs, is arranged in the network element. It is clear to a person skilled in the art that a network element according to the invention can also comprise other means, such as means for controlling the connection, in addition to the ones mentioned above.

A telecommunication system according to the invention, which includes at least two telecommunication networks, comprises, in addition to the network elements of the system, at least a mobile station, which can incorporate more than one subscriber identifier. According to the invention, at least in one of said telecommunication networks, a common subscriber identifier has been arranged for an individual mobile station, and a connection can be arranged between a mobile station of sail telecommunication network and at least one other telecommunication network. In addition, the telecommunication system comprises means, by which, in a situation where a connection is being established to said mobile station or from said mobile station, information of the telecommunication system saved in other means, such as information of the common subscriber identifier, can be updated. A common subscriber identifier means such data or database, through which individual subscriber identifiers in the same mobile station can be reached. According to the invention, information of the common subscriber identifier is updated in a situation where a connection is set up from the first telecommunication network to the second telecommunication network via a network element, which connects these two. The network element, which connects said systems, detects communication between the first and the second telecommunication network and asks a mobile station, which can incorporate more than one subscriber identifier to transmit the information of the common subscriber identifier. When the element, which connects the networks, has received the information, it sends an update request for the common subscriber identifier, in which update request information about the common subscriber identifier is transmitted. In a telecommunication system according to the invention, information of the common subscriber identifier is updated in the network element of the system, in which information about the subscribers is stored.

It is clear to a person skilled in the art that in a situation where the core network comprises only one node, the updating procedure of the common subscriber identifier described above can be entirely omitted. This can be arranged e.g. by configuring the IWU so that it is not necessary to perform the subscriber identifier updating procedure. By an arrangement like this, unnecessary signalling can be avoided, because the mobile station, which participates in the connection, incorporates only one subscriber identifier.

It is clear to a person skilled in the art that an updating procedure according to the above description can either be performed when a connection is being established or after the connection has been established.

In the exemplary cases described above, one of the mobile communication networks is a GSM network and the other one an UMTS network, preferably so that said first mobile communication network is an UMTS network and said second mobile communication network is a GSM network. Especially in the case of an UMTS network, the part concerned is the radio network part of the network. However, it is clear to a person skilled in the art that the networks can also be other network systems. The method according to the invention is particularly advantageously applied in such a mobile communication system in which a mobile station of the system can incorporate more than one subscriber identifier, and information about each subscriber identifier in the same mobile station is stored in the system under a common subscriber identifier. A solution according to the invention can also be applied in a case when the network system, which participates in setting up the connection is a public switched telephone network.

The invention described above can be applied within the scope of the inventive idea defined by the attached claims.

1. A method for updating subscriber identifier information in a first mobile communication network, in which a common subscriber identifier has been arranged for an individual mobile station, and a connection is established between a mobile station of said first mobile communication network and a second mobile communication network, characterized in that when a connection is established between said mobile station and the second telecommunication network at least the information of the common subscriber identifier of the first mobile communication network is updated from the network element that connects said networks.

2. A method according to claim 1, characterized in that subscriber identifier information is requested from the subscriber identifier that participates in establishing the connection.

3. A method according to claim 2, characterized in that at least information about the subscriber identifier of the mobile station is transmitted in the message for updating the common subscriber identifier of the common network element that connects said networks.

4. A method according to claim 3, characterized in that said information comprises at least the IMSI code of the subscriber identifier.

5. A method according to claim 1, characterized in that when the mobile station comprises one subscriber identifier, the IMSI code of that one subscriber identifier is used as the common subscriber identifier of the mobile communication network.

6. A method according to claim 1, characterized in that when the connection is established, the information of the common subscriber identifier and temporary subscriber information is stored in the network element that connects said networks.

7. A method according to claim 1, characterized in that
an identification request is sent for identifying the subscriber identifier that participates in the connection
information of the subscriber identifier mentioned in the response message is received
information of the common subscriber identifier is updated.

8. A network element for updating subscriber identifier information in the first mobile communication network, in which a common subscriber identifier has been arranged for an individual mobile station, and a connection is arrangable between said first mobile communication network and the second telecommunication network, characterized in that said network element comprises
first means (801) for transmitting and identifying signals between the first mobile communication network and the second telecommunication network,
second means (802) for transmitting an identification request,
third means (803) for processing the identification information, and
fourth means (804) for transmitting an updating message.

9. A network element according to claim 8, characterized in that it is an interworking unit IWU.

10. A network element according to claim 8, characterized in that it is arranged to transmit an identification request to a mobile station of the first mobile communication network.

11. A network element according to claim 8, characterized in that it is arranged to transmit an updating message to the network element that stores the information of the common subscriber identifier.

12. A network element according to claim 11, characterized in that said network element that stores the information of the common subscriber identifier is a radio network controller (RNC).

13. A network element according to claim 8, characterized in that said first mobile communication network is the radio network part of an UMTS network.

14. A telecommunication system, which comprises at least two telecommunication networks, and in at least one telecommunication network a common subscriber identifier has been arranged for an individual mobile station, and a connection is arrangable between a mobile station of said mobile communication network and at least one other telecommunication network, characterized in that said telecommunication system comprises means between said telecommunication network and said at least one other telecommunication network for updating the information of the common subscriber identifier by means of an updating message.
